(19) United States
(12) Patent Application Publication
(10) Pub. No.: US 2016/0182579 A1
(43) Pub. Date: Jun. 23, 2016

(54) METHOD OF ESTABLISHING AND MANAGING MESSAGING SESSIONS BASED ON USER POSITIONS IN A COLLABORATION SPACE AND A COLLABORATION SYSTEM EMPLOYING SAME

(71) Applicant: SMART Technologies ULC, Calgary (CA)

(72) Inventor: Kenny TSANG, Calgary (CA)

(21) Appl. No.: 14/580,332

(22) Filed: Dec. 23, 2014

(51) Int. Cl. H04L 29/06; H04L 12/58

(52) U.S. Cl. CPC H04L 65/4015; H04L 65/1069; H04L 65/4053; H04L 51/04

(57) ABSTRACT

A computerized method and system of managing a collaboration space having a plurality of users collaborating therein, the method comprising: establishing a plurality of messaging sessions, said messaging sessions being associated with said a plurality of users based on user positions or areas in the collaboration space.

### FIELD OF THE DISCLOSURE

The present invention relates generally to collaboration, and in particular to a method of establishing and managing messaging sessions in a collaboration session based on user locations in a collaboration space and a collaboration system employing same.

### BACKGROUND

Collaboration systems are known. Generally, a collaboration system comprises a plurality of computing devices interconnected via a communication network for users to collaborate with each other. For example, SMART Meeting Pro™ offered by SMART Technologies ULC of Calgary, Alberta, Canada, allows a group of users at different locations to establish a collaboration session using their computing devices via a communication network. During collaboration, SMART Meeting Pro™ establishes audio, video and data communication between users via one or more servers in the network. Users in the collaboration session may share one or more whiteboard pages or a user's computer screen. Users in the collaboration session may inject digital ink annotation, images and/or other multimedia contents on the shared whiteboard page or computer screen, share audio/video stream to other users in the collaboration session, and/or send text message to other users in the collaboration session.

Other collaboration systems, such as Cisco WebEx®, Citrix® GoToMeeting®, Microsoft® Lync®, etc., are also available. These collaboration systems allow users in a collaboration session to share text, images and audio/video streams.

Generally, the above mentioned collaboration systems facilitate collaboration of a plurality of users by providing a collaboration space such as a digital canvas for users to inject thereon various graphic objects such as digital ink, lines, shapes, images, text, animation, graphic representations of sounds and other types of multimedia content, and the like. A user may adjust the display of the interactive input system to different zoom levels as desired to improve readability or comprehension of the information.

Zoomable user interfaces have been considered. For example, Internet-based “online” map applications such as Google Maps™ offered by Google Inc. of Mountain View, Calif., USA, provide zoomable user interfaces to allow users to adjust the displayed maps to various levels of detail as desired.

U.S. Patent Publication No. 2013/0198653 assigned to SMART Technologies ULC of Calgary, Alberta, Canada, assignee of the subject disclosure, the content of which is incorporated herein by reference in its entirety, discloses a method of displaying input during a collaboration session, comprising providing a canvas or workspace for receiving input from at least one participant using a computing device joined to the collaboration session; and displaying the canvas at one of a plurality of discrete zoom levels on a display associated with the computing device. In one embodiment, the canvas is configured to be extended in size within its two-dimensional plane to accommodate new input as needed during the collaboration session. Such a dynamically extendable canvas or workspace is sometimes denoted as an “infinite canvas” or “unbounded workspace”.

To further facilitate user collaboration, most of the above mentioned collaboration systems provide a text messaging function for users to chat with each other using text messaging. A user may send a text message to another user in the same collaboration session, or may broadcast a text message to all users in the same collaboration session.

A drawback of such a text messaging system is that the text messaging is not always associated with the specific user's interest in the collaboration, and may interfere with the user's contributions and effectiveness. For example, in a collaboration session, some users may be in collaboration on a first topic and some other users may be in collaboration on a second topic. A user A in the collaboration session wanting to send a text message to a user B working on the same topic may experience difficulty in finding the name of user B from all the users in the same collaboration session. Moreover, users may suffer distracting interference by messages sending from a user in the same collaboration session but working on a different topic.

It is therefore an object to provide a novel method of establishing a more effective messaging session in a collaboration session and a collaboration system employing same.

### SUMMARY

According to one aspect of this disclosure, there is provided a computerized method of managing a collaboration space having a plurality of users collaborating therein, the method comprising: identifying one or more areas within the collaboration space, each of the one or more areas being attended by at least one user; establishing a messaging session for each identified area; and associating each user attending the same area with the same messaging session.

In some embodiments, each user is associated with a viewport, and each viewport represents at least a portion of the one or more areas.

In some embodiments, said establishing a messaging session for each identified area comprises: for each viewport, establishing a messaging session for users associated therewith; and associating said messaging session with said viewport.

In some embodiments, said establishing a messaging session for each identified area comprises: identifying a first set of interrelated viewports, said first set of interrelated viewports being a first plurality of viewports that overlap a first common area of the collaboration space, the size of said first common area being more than a predefined threshold percentage of that of at least one of said a first plurality of viewports; and establishing a first messaging session for users associated with the first set of interrelated viewports.

In some embodiments, said establishing a messaging session for each identified area further comprises: associating said first messaging session with the first set of interrelated viewports.

In some embodiments, said establishing a messaging session for each identified area in the collaboration space further comprises: identifying a second set of interrelated viewports, said second set of interrelated viewports being a second plurality of viewports that overlap a second common area of the collaboration space, the size of said second common area being more than a predefined threshold percentage of that of at least one of said a second plurality of viewports; and establishing a second messaging session for users associated with the second set of interrelated viewports.

In some embodiments, said establishing a messaging session for each identified area further comprises: associating said second messaging session with the second set of interrelated viewports.

In some embodiments, the first and second sets of viewports comprise at least one common viewport, and each user associated with said at least one common viewport is simultaneously in the first and second messaging sessions.

In some embodiments, said establishing a messaging session for each identified area in the collaboration space comprises: identifying a first set of interrelated viewports; identifying a second set of interrelated viewports, the second set of interrelated viewports being linked to the first set of interrelated viewports via a set of intermediate viewports; establishing a messaging session for users associated with the first and second sets of viewports; and associating said messaging session with the first and second sets of viewports.

In some embodiments, the method further comprises: receiving a command from a user, said command comprising an instruction of associating the user with a target viewport; associating the user with the target viewport; and joining the user into every messaging session associated with the target viewport.

In some embodiments, the method further comprises: receiving a command from a user, said command comprising an instruction of leaving the viewport that the user is associated therewith; cancelling the association between the user and said viewport; and removing the user from every messaging session associated with said viewport.

In some embodiments, the method further comprises: determining that a first viewport of a set of interrelated viewports becomes unrelated with said set of interrelated viewports; removing users of the first viewport from every messaging session associated with said set of interrelated viewports; and establishing a messaging session for users associated with the first viewport.

In some embodiments, the method further comprises: determining that a second viewport becomes interrelated with one or more third viewports; and establishing a messaging session for users associated with the second viewport and the one or more third viewports.

According to another aspect of this disclosure, there is provided a system for managing a collaboration space having a plurality of users collaborating therein, the system comprising: a network; a plurality of processing structures functionally coupled to said network; and at least one memory functionally coupled to at least one of said processing structures; wherein said at least one of said processing structures executes computer-executable code for: identifying one or more areas within the collaboration space, each of the one or more areas being attended by at least one user; establishing a messaging session for each identified area; and associating each user attending the same area with the same messaging session.

In some embodiments, each user is associated with a viewport, and wherein each viewport represents at least a portion of the one or more areas.

In some embodiments, said computer-executable code for establishing a messaging session for each identified area comprises computer-executable code for: for each viewport, establishing a messaging session for users associated therewith; and associating said messaging session with said viewport.

In some embodiments, said computer-executable code for establishing a messaging session for each identified area comprises computer-executable code for: identifying a first set of interrelated viewports, said first set of interrelated viewports being a first plurality of viewports that overlap a first common area of the collaboration space, the size of said first common area being more than a predefined threshold percentage of that of at least one of said a first plurality of viewports; establishing a first messaging session for users associated with the first set of interrelated viewports; and associating said first messaging session with the first set of interrelated viewports.

In some embodiments, said computer-executable code for establishing a messaging session for each identified area in the collaboration space further comprises computer-executable code for: identifying a second set of interrelated viewports, said second set of interrelated viewports being a second plurality of viewports that overlap a second common area of the collaboration space, the size of said second common area being more than a predefined threshold percentage of that of at least one of said a second plurality of viewports; establishing a second messaging session for users associated with the second set of interrelated viewports; and associating said second messaging session with the second set of interrelated viewports.

In some embodiments, the first and second sets of viewports comprise at least one common viewport, and each user associated with said at least one common viewport is simultaneously in the first and second messaging sessions.

In some embodiments, said computer-executable code for establishing a messaging session for each identified area in the collaboration space comprises computer-executable code for: identifying a first set of interrelated viewports; identifying a second set of interrelated viewports, the second set of interrelated viewports being linked to the first set of interrelated viewports via a set of intermediate viewports; establishing a messaging session for users associated with the first and second sets of viewports; and associating said messaging session with the first and second sets of viewports.

In some embodiments, said at least one of said processing structures further executes computer-executable code for: receiving a command from a user, said command comprising an instruction of associating the user with a target viewport; associating the user with the target viewport; and joining the user into every messaging session associated with the target viewport.

In some embodiments, said at least one of said processing structures further executes computer-executable code for: receiving a command from a user, said command comprising an instruction of leaving the viewport that the user is associated therewith; cancelling the association between the user and said viewport; and removing the user from every messaging session associated with said viewport.

In some embodiments, said at least one of said processing structures further executes computer-executable code for: determining that a first viewport of a set of interrelated viewports becomes unrelated with said set of interrelated viewports; removing users of the first viewport from every messaging session associated with said set of interrelated viewports; and establishing a messaging session for users associated with the first viewport.

In some embodiments, said at least one of said processing structures further executes computer-executable code for: determining that a second viewport becomes interrelated with one or more third viewports; and establishing a messaging session for users associated with the second viewport and the one or more third viewports.

According to another aspect of this disclosure, there is provided a computer-readable storage device comprising computer-executable instructions for managing a collaboration space having a plurality of users collaborating therein, wherein the instructions, when executed, cause a processor to perform actions comprising: identifying one or more areas within the collaboration space, each of the one or more areas being attended by at least one user; establishing a messaging session for each identified area; and associating each user attending the same area with the same messaging session.

In some embodiments, each user is associated with a viewport, and wherein each viewport represents at least a portion of the one or more areas.

In some embodiments, said establishing a messaging session for each identified area comprises: for each viewport, establishing a messaging session for users associated therewith; and associating said messaging session with said viewport.

In some embodiments, said establishing a messaging session for each identified area comprises: identifying a first set of interrelated viewports, said first set of interrelated viewports being a first plurality of viewports that overlap a first common area of the collaboration space, the size of said first common area being more than a predefined threshold percentage of that of at least one of said a first plurality of viewports; establishing a first messaging session for users associated with the first set of interrelated viewports; and associating said first messaging session with the first set of interrelated viewports.

In some embodiments, said establishing a messaging session for each identified area in the collaboration space further comprises: identifying a second set of interrelated viewports, said second set of interrelated viewports being a second plurality of viewports that overlap a second common area of the collaboration space, the size of said second common area being more than a predefined threshold percentage of that of at least one of said a second plurality of viewports; establishing a second messaging session for users associated with the second set of interrelated viewports; and associating said second messaging session with the second set of interrelated viewports.

In some embodiments, the first and second sets of viewports comprise at least one common viewport, and each user associated with said at least one common viewport is simultaneously in the first and second messaging sessions.

In some embodiments, said establishing a messaging session for each identified area in the collaboration space comprises: identifying a first set of interrelated viewports; identifying a second set of interrelated viewports, the second set of interrelated viewports being linked to the first set of interrelated viewports via a set of intermediate viewports; establishing a messaging session for users associated with the first and second sets of viewports; and associating said messaging session with the first and second sets of viewports.

In some embodiments, said actions further comprises: receiving a command from a user, said command comprising an instruction of associating the user with a target viewport; associating the user with the target viewport; and joining the user into every messaging session associated with the target viewport.

In some embodiments, said actions further comprises: receiving a command from a user, said command comprising an instruction of leaving the viewport that the user is associated therewith; cancelling the association between the user and said viewport; and removing the user from every messaging session associated with said viewport.

In some embodiments, said actions further comprises: determining that a first viewport of a set of interrelated viewports becomes unrelated with said set of interrelated viewports; removing users of the first viewport from every messaging session associated with said set of interrelated viewports; and establishing a messaging session for users associated with the first viewport.

In some embodiments, said actions further comprises: determining that a second viewport becomes interrelated with one or more third viewports; and establishing a messaging session for users associated with the second viewport and the one or more third viewports.

According to another aspect of this disclosure, there is provided a computerized method of managing a collaboration space having a plurality of users collaborating therein, the method comprising: identifying the position of each user in the collaboration space; establishing a plurality of messaging sessions; and associating each messaging session with a plurality of users based on user positions in the collaboration space.

In some embodiments, said associating each messaging session with a plurality of users comprises: associating a messaging session with a group of users at about the same position in the collaboration space.

### BRIEF DESCRIPTION OF THE DRAWINGS

FIG. 1 is a perspective view of an example of a collaboration system, according to an embodiment of the present disclosure;

FIG. 2 shows an example of a computing device of the collaboration system of FIG. 1;

FIG. 3 shows the hardware structure of a computing device of the collaboration system of FIG. 1;

FIG. 4 shows a simplified software architecture of a computing device of the collaboration system of FIG. 1.

FIG. 5 illustrates an example of a collaboration space and two viewports overlapping therein, managed by the collaboration system of FIG. 1;

FIG. 6 shows the display image of a viewport displayed on the screen of a client computing device;

FIG. 7 shows the collaboration space and the two viewports overlapping therein of FIG. 5 after a user has manipulated one of the viewports;

FIG. 8 shows the display image of the user-manipulated viewport of FIG. 7;

FIGS. 9 and 10 show a flowchart illustrating the steps of a process for establishing and managing a collaboration session;

FIG. 11 shows an example of a collaboration space and two viewports overlapping therein;

FIGS. 12A to 12F show an example of a user manipulating a viewport of FIG. 11, and the updating of messaging sessions in response to user manipulation;

FIGS. 13A and 13B show an example of a user manipulating a viewport of FIG. 11, and the updating of messaging sessions in response to user manipulation, according to an alternative embodiment;

FIGS. 14A and 14B show a portion of a flowchart illustrating the steps of updating messaging sessions, according to an alternative embodiment;

FIGS. 15 to 17 show an example of a user manipulating a viewport of FIG. 11, and the updating of messaging sessions in response to user manipulation; and

FIGS. 18 and 19 illustrate an example of linked viewports.

### DETAILED DESCRIPTION

Herein, methods for establishing and managing messaging sessions for users of a collaboration space are described. As follows, the system supporting the process and operation of such collaboration space are set forth before the embodiments for establishing and managing messaging sessions are described.

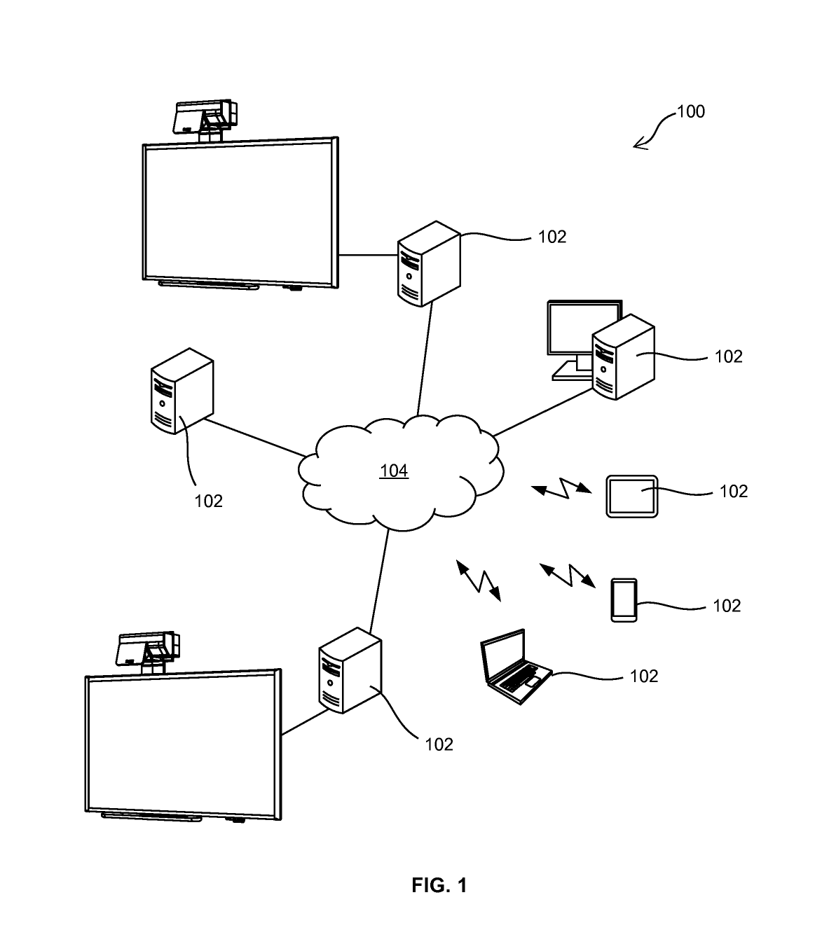

Turning now the FIG. 1, a collaboration system is shown and is generally identified by reference numeral 100. In this embodiment, the collaboration system 100 comprises two or more computing devices 102, such as server computers, computing devices having interactive whiteboards, desktop computers, laptop computers, tablets, smartphones, Personal Digital Assistants (PDAs) and the like, interconnected by a network 104, such as Internet, a local area network (LAN), a wide area network (WAN) or the like, via suitable wired and wireless networking connections. Generally, the computing devices 102 may be classified as server computers running one or more server programs, and client computing devices running one or more client application programs and for user to use.

Depending on implementation, the server computer may be a stand-along computing device, or alternatively, a client computing device in the collaboration system may act as a server computer while also being used by a user.

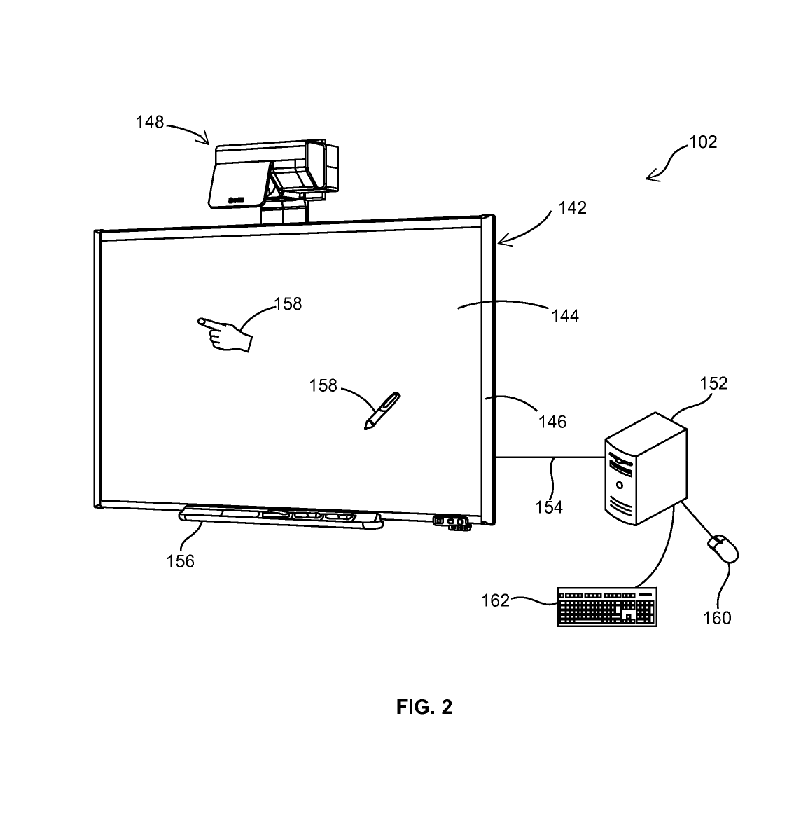

FIG. 2 shows an example of a computing device 102 of the collaboration system 100, which allows one or more users to inject input such as digital ink, mouse events, commands, etc., into an executing application program, by using one or more pointers 158 such fingers, palms, fists, pen tools, erasers, cylinders or other suitable objects. As shown, the interactive input system 100 comprises a two-dimensional (2D) interactive device in the form of an interactive whiteboard (IWB) 142 mounted on a vertical support surface such as a wall surface or the like. The IWB 142 displays a collaboration space within which graphic objects are created, displayed and managed.

The IWB 142 comprises a generally planar, rectangular interactive surface 144 that is surrounded about its periphery by a bezel 146. An ultra-short-throw projector 148, such as that sold by SMART Technologies ULC under the name “SMART UX60”, is also mounted on the support surface above the IWB 142 and projects an image, such as for example, a computer desktop, onto the interactive surface 144.

The IWB 142 employs machine vision to detect one or more pointers brought into a region of interest in proximity with the interactive surface 144. The IWB 142 communicates with a general purpose computing device 152 via a universal serial bus (USB) cable 154 or other suitable wired or wireless communication link. The general purpose computing device 152 executes one or more application programs to process the output of the IWB 142 and adjusts image data that is output to the projector 148, if required, so that the image presented on the interactive surface 144 reflects pointer activity. In this manner, the IWB 142, general purpose computing device 152 and projector 148 allow pointer activity proximate to the interactive surface 144 to be recorded as writing or drawing or used to control execution of one or more application programs executed by the general purpose computing device 152.

The bezel 146 is mechanically fastened to the interactive surface 144 and comprises four bezel segments that extend along the edges of the interactive surface 144. In this embodiment, the inwardly facing surface of each bezel segment comprises a single, longitudinally extending strip or band of retro-reflective material. To take best advantage of the properties of the retro-reflective material, the bezel segments are oriented so that their inwardly facing surfaces lie in a plane generally normal to the plane of the interactive surface 144.

A tool tray 156 is affixed to the IWB 142 adjacent the bottom bezel segment using suitable fasteners such as for example, screws, clips, adhesive, etc. As can be seen, the tool tray 156 comprises a housing having an upper surface configured to define a plurality of receptacles or slots. The receptacles are sized to receive one or more pen tools as well as an eraser tool that can be used to interact with the interactive surface 144. Control buttons (not shown) are also provided on the upper surface of the tool tray housing to enable a user to control operation of the interactive input system 100.

Imaging assemblies (not shown) are accommodated by the bezel 146, with each imaging assembly being positioned adjacent a different corner of the bezel. Each of the imaging assemblies comprises an image sensor and associated lens assembly that provides the image sensor with a field of view sufficiently large as to encompass the entire interactive surface 144. A digital signal processor (DSP) or other suitable processing device sends clock signals to the image sensor causing the image sensor to capture image frames at the desired frame rate. During image frame capture, the DSP also causes an infrared (IR) light source to illuminate and flood the region of interest over the interactive surface 144 with IR illumination. Thus, when no pointer exists within the field of view of the image sensor, the image sensor sees the illumination reflected by the retro-reflective bands on the bezel segments and captures image frames comprising a continuous bright band. When a pointer exists within the field of view of the image sensor, the pointer occludes IR illumination and appears as a dark region interrupting the bright band in captured image frames.

The imaging assemblies are oriented so that their fields of view overlap and look generally across the entire interactive surface 144. In this manner, any pointer brought into proximity of the interactive surface 144 appears in the fields of view of the imaging assemblies and thus, is captured in image frames acquired by multiple imaging assemblies. When the imaging assemblies acquire image frames in which a pointer exists, the imaging assemblies convey pointer data to the general purpose computing device 152.

The general purpose computing device 152 in this embodiment is a personal computer or other suitable processing device comprising, for example, a processing unit, system memory (volatile and/or non-volatile memory), other non-removable or removable memory (e.g., a hard disk drive, RAM, ROM, EEPROM, CD-ROM, DVD, solid-state memory, flash memory, etc.), and a system bus coupling the various computer components to the processing unit. The general purpose computing device 152 may also comprise networking capabilities using Ethernet, WiFi, and/or other suitable network format, to enable connection to shared or remote drives, one or more networked computers, or other networked devices. A mouse 160 and a keyboard 162 are coupled to the general purpose computing device 152.

The general purpose computing device 152 processes pointer data received from the imaging assemblies to resolve pointer ambiguity by combining the pointer data generated by the imaging assemblies, and to compute the locations of pointers proximate the interactive surface 144 using well known triangulation. The computed pointer locations are then recorded as writing or drawing or used an input command to control execution of an application program as described above.

In addition to computing the locations of pointers proximate to the interactive surface 144, the general purpose computing device 152 also determines the pointer types (e.g., pen tool, finger or palm) by using pointer type data received from the IWB 142. The pointer type data is generated for each pointer contact by the DSP of at least one of the imaging assemblies by differentiating a curve of growth derived from a horizontal intensity profile of pixels corresponding to each pointer tip in captured image frames. Specifics of methods used to determine pointer type are disclosed in U.S. Pat. No. 7,532,206 to Morrison, et al., and assigned to SMART Technologies ULC, the content of which is incorporated herein by reference in its entirety.

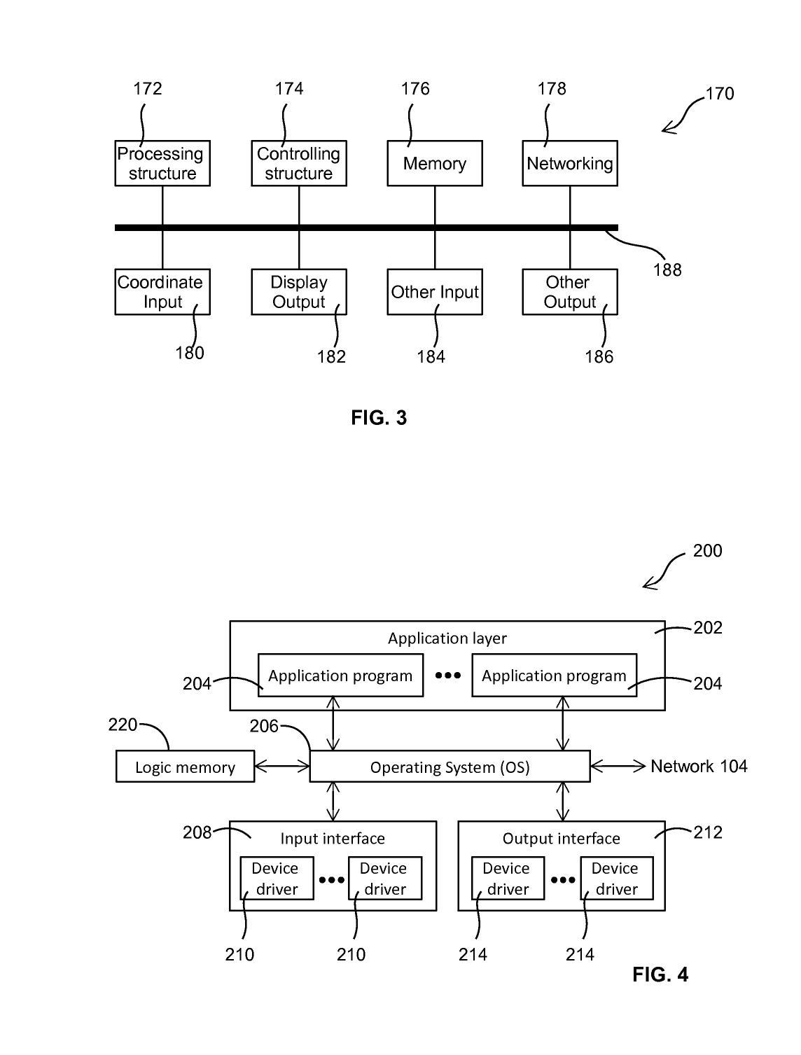

FIG. 3 shows the hardware structure 170 of a computing device 102 of the collaboration system 100. The computing device 102 comprises a processing structure 172, a controlling structure 174, memory or storage 176, a networking structure 178, coordinate input 180, display output 182, and other input and output modules 184 and 186, all functionally interconnected by a system bus 188.

The processing structure 172 may be one or more single-core or multiple-core computing processors such as Intel® microprocessors offered by Intel Corporation of Santa Clara, Calif., USA, AMD® microprocessors offered by Advanced Micro Devices of Sunnyvale, Calif., USA, ARM® microprocessors manufactured by a variety of manufactures under the ARM® architecture developed by ARM Ltd. of Cambridge, UK, or the like.

The controlling structure 174 comprises a plurality of controllers, such as graphic controllers, input/output chipsets and the like, for coordinating operations of various hardware components and modules of the computing device 102.

The memory 176 comprises a plurality of storage units accessible by the processing structure 172 and the controlling structure 174 for reading and/or storing data, including input data and data generated by the processing structure 172 and the controlling structure 174. The memory 176 may be volatile and/or non-volatile, non-removable or removable memory such as RAM, ROM, EEPROM, solid-state memory, hard disks, CD, DVD, flash memory, or the like. In use, the memory 176 is generally divided to a plurality of portions for different use purposes. For example, a portion of the memory 176 may be used for long-term data storing, e.g., storing files or databases, and/or for caching data that is not currently used by the processing structure 172 and/or the controlling structure 174, e.g., as a so-called “virtual memory”. Another portion of the memory 176 may be used as the system memory for storing data during processing.

The networking structure 178 comprises one or more networking modules for connecting to other computing devices or networks via wired or wireless connections such as Ethernet, WiFi®, Bluetooth®, wireless phone channels, ZigBee®, or the like. In some embodiments, parallel ports, serial ports, USB connections may also be used for connecting other computing devices or networks although they are usually considered as input/output interfaces for connecting input/output devices.

The display output 182 comprises one or more display modules for displaying images, such as monitors, LCD displays, LED displays, projectors, and the like. The display output 182 may be a physically integrated part of the computing device 102 (e.g., the display of a laptop computer or tablet), or may be a display device physically separate from, but functionally coupled to, other components of the computing device 102 (e.g., the monitor of a desktop computer).

The coordinate input 180 comprises one or more input modules for one or more users to input coordinate data such as touch-sensitive screen, touch-sensitive whiteboard, trackball, computer mouse, touch-pad, or other human interface devices (HID) and the like. The coordinate input 180 may be a physically integrated part of the computing device 102 (e.g., the touch-pad of a laptop computer or the touch-sensitive screen of a tablet), or may be a display device physically separate from, but functionally coupled to, other components of the computing device 102 (e.g., a computer mouse). The coordinate input 180, in some implementation, may be integrated with the display output 182 to form a touch-sensitive screen or touch-sensitive whiteboard.

The computing device 102 may also comprise other input 184 such as keyboards, microphones, scanners and the like. The computing device 102 may further comprise other output 186 such as speakers, printers and the like.

The system bus 188 interconnects various components 172 to 186 enabling them to transmit and receive data and control signals to/from each other.

FIG. 4 shows a simplified software architecture 200 of a computing device 102 of the collaboration system 100. The software architecture 200 comprises an application layer 202, an operating system 204, an input interface 208, an output interface 212 and logic memory 220. The application layer 202 comprises one or more application programs 204 executed or run by the processing structure 102 for performing various tasks. The operating system 204 manages various hardware components of the computing device 102 via the input interface 208 and the output interface 212, manages logic memory 220, and manages and supports the application programs 206. The operating system 206 is also in communication with other computing devices (not shown) via the network 104 to allow application programs 206 to communicate with application programs running on other computing devices. As those skilled in the art appreciate, the operating system 204 may be any suitable operating system such as Microsoft® Windows™, Apple® OS X®, Apple® iOS®, Linux®, Android™ or the like. The computing devices 102 of the collaboration system 100 may all have the same operating system, or may have different operating systems.

The input interface 208 comprises one or more input device drivers 210 for communicating with respective input devices including the coordinate input 150, and the output interface 212 comprises one or more output device drivers 214 managed by the operating system 206 for communicating with respective output devices including the display output 152. Input data received from the input devices via the input interface 208 is sent to the application layer 202, and is processed by one or more application programs 204. The output generated by the application programs 204 is sent to respective output devices via the output interface 212.

The logical memory 220 is a logical mapping of the physical memory 146 for facilitating the application programs 204 to access. In this embodiment, the logical memory 220 comprises a storage area (not shown) that is usually mapped to non-volatile physical memory, such as hard disks, solid state disks, flash drives and the like, for generally long-term storing data therein. The logical memory 220 also comprises a working area (not shown) that is generally mapped to high-speed, and in some implementations volatile, physical memory, such as RAM, for application programs 204 to generally temporarily store data during program execution. For example, an application program 204 may load data from the storage area into the working area, and may store data generated during its execution in the working area. The application program 204 may also store some data to the storage area as required or in response to a user's command.

In this embodiment, the collaboration system 100 executes the processor-readable code of an application program 204, e.g., SMART Meeting Pro™ or Amp™ offered by SMART Technologies ULC of Calgary, Alberta, Canada, to manage a collaboration space. The application program comprises a server side program module running on one or more server computers and a client side program module running on one or more client computing devices. The server side program module manages one or more collaboration sessions for users of client computing devices 102 in the system. The server-side program module communicates with the client side program module of each client computing device joined to a collaboration session, and shares content of the collaboration session therewith. For each collaboration session, the server side program module creates and maintains a collaboration space, and in response to user input received from the client side program module, manipulates the collaboration space and the graphic objects therein. Herein, user input includes user input received from an input device directly connected to the computing device running both the server side program module and the client side program module (when the server computer is also used as a client computing device), and user input received from a remote client computing device via the network 104.

The client side program module interacts with the user, displays the collaboration space or a portion thereof to the user via a viewport, and processes and transmits user input to the server side program.

Herein, the collaboration space is a digital space or canvas for accommodating graphic objects. As those skilled in the art appreciate, graphic objects are arranged on a (x, y) plane of the collaboration space with respective z-order such that a graphic object having a larger z-order value appears above another graphic object having a smaller z-order. In this embodiment, the collaboration space is an infinite canvas, i.e., its size may be dynamically increase or decrease based on the locations of graphic objects located thereon. For example, when a user moves a graphic object in the collaboration space to a location away from another graphic object, the collaboration space dynamically increases its size to accommodate both graphic objects. As another example, when all graphic objects in the collaboration space are positioned closed to each other, the size of the collaboration space may be small. Further, the collaboration space may be entirely contained within a browser software.

Herein, a viewport represents a view of at least a portion of the collaboration space, which may be presented on the screen(s) of one or more user's computing devices as a screen image for users to view the collaboration space. The position or area of a viewport in the collaboration space represents the position or area in the collaboration space of the user(s) associated with the viewport.

In various embodiments, a computing device may be used by a single user or by multiple users. In some embodiments, when a computing device is used by multiple users, the multiple users are working on the same viewport displayed on the screen of the computing device. In this embodiment, a user manipulating the viewport (described in more detail later) will affect all other users working on the same viewport. In some other embodiments, multiple users using the same computing device may each have a separate viewport, which may be implemented using so called split screen technology that divides the screen of the computing device to multiple zones each being used by a user for showing the user's viewport.

The application program 204 allows a plurality of users to work in the same collaboration space.

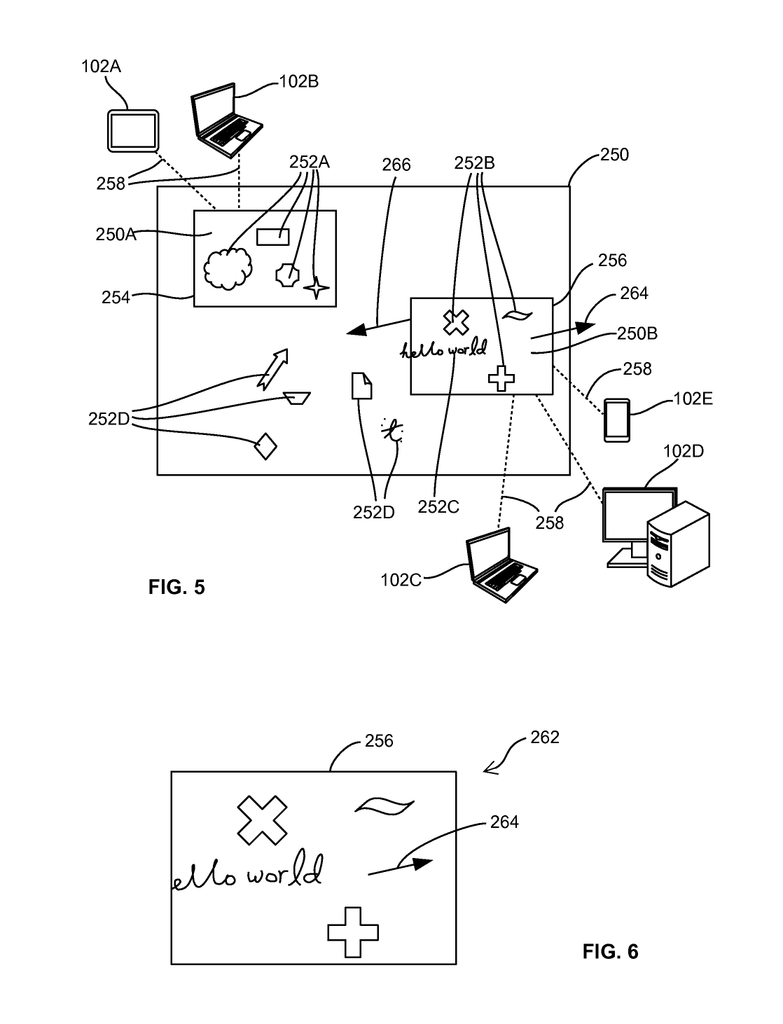

With reference to FIG. 5, an example is shown, wherein a server maintains and manages a collaboration space 250 having a plurality of graphic objects 252A to 252D therein. As shown, the server creates two viewports 254 and 256 in the collaboration space 250, each of which overlaps with at least a portion of the collaboration space 250. Users in the collaboration session may switch between the viewports 254 and 256 to view the collaboration space 250.

For economy, a collection of five users of computing devices 102A to 102E are discussed herein, selected from a plurality of users collaborating in the collaboration space 250. In particular, users of computing devices 102A and 102B are associated with viewport 254, indicated by the broken lines 258, and users of computing devices 102C, 102D and 102E are associated with the viewport 256, indicated by the broken lines 258. Consequently, the portion 250A of the collaboration space 250 and graphic objects 252A that overlap with the viewport 254 are displayed on the screens of client computing devices 102A and 102B; and the portion 250B of the collaboration space 250 and graphic objects 252B that overlap with the viewport 256 are displayed on the screens of client computing devices 102C, 102D and 102E. The graphic object 252C partially overlaps with the viewport 256, and thus only the overlapped portion of the graphic object 252C is displayed on the screens of client computing devices 102C, 102D and 102E.

Each user of computing devices 102A to 102E may manipulate the graphic objects displayed on the screen of their computing devices, which are the graphic objects overlapping the respective viewport that the user is associated therewith. The manipulation is then updated to all other users associated with the same viewport. Each user of computing devices 102A to 102E may also manipulate the collaboration space 250 by, e.g., panning, rotating, zooming-in or zooming-out the collaboration space 250, which is effectively converted to the manipulation of the respective viewport that the user is associated therewith, and the result of collaboration space manipulation is updated to all other users associated with the same viewport.

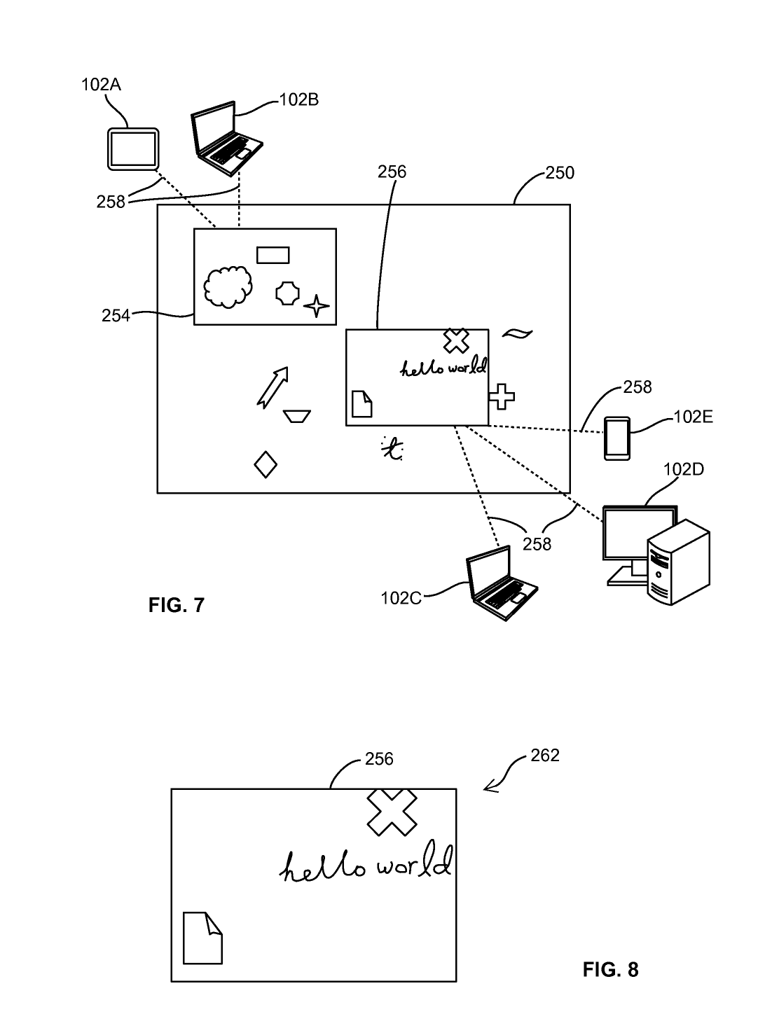

For example, FIG. 6 shows the display image 262 of the viewport 256 displayed on the screen of client computing device 102C. The user of the computing device 102C apply a moving gesture on the display image 262 corresponding to the collaboration space 250 to initiate a command of moving the collaboration space 250 along a direction 264. Also referring to FIG. 5, the collaboration space moving command is correspondingly converted to a command of moving the viewport 256 along an opposite direction 266. Consequently, as shown in FIG. 7, the viewport 256 is moved to a new location in the collaboration space 250. As shown in FIG. 8, the display image 262 of the viewport 256 is updated and displayed on the screens of the associated computing devices 102C, 102D and 102E.

When a user zooms in the collaboration space in a viewport, the collaboration zooming-in command is converted to a command of reducing the size of the viewport (i.e., zooming-out the viewport). Similarly, a collaboration zooming-out command is converted to a command of enlarging the size of the viewport (i.e., zooming-in the viewport).

Having set forth the environment for the manipulation of a collaboration space and graphic objects therein, one turns to the methods for establishing and managing a collaboration session for users. Generally, the system 100 establishes a collaboration space for a collaboration session, and establishes one or more viewports for facilitating users to work in the collaboration space. The system 100 partitions users in the collaboration space into a plurality of groups based on the positions or areas of the users in the collaboration space, and establishes a messaging session for each group of users. In this embodiment, the messaging session is text messaging session for users to communicate via text messages.

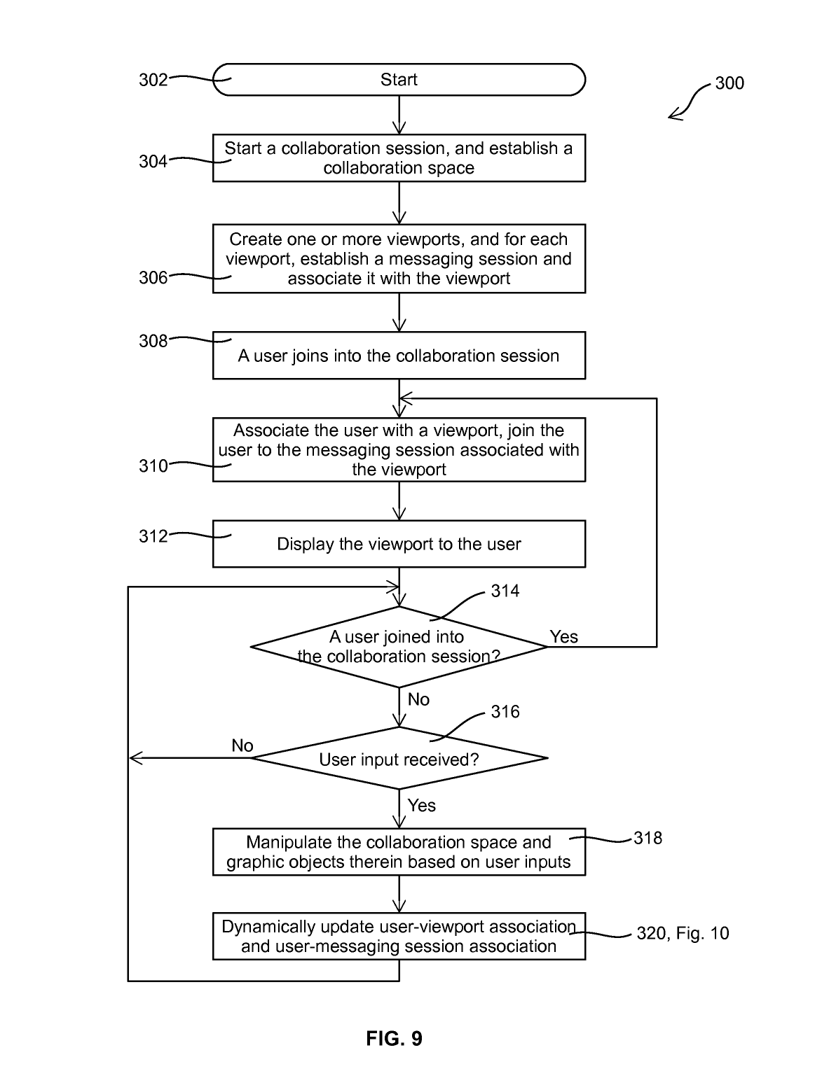

FIG. 9 shows a flowchart illustrating the steps of a process 300 for establishing and managing a collaboration session with inter-user communication.

The process starts when a collaboration session is started (step 302), either in response of a user command or when a scheduled collaboration time has reached, depending on the implementation. The system 100 starts the collaboration session, and establishes a collaboration space (step 304). As those skilled in the art appreciate, the collaboration space may be a newly created collaboration space or a collaboration space established based on data previously stored in the system 100.

The system 100 stores a predefined viewport information regarding the default number and locations of viewports that the system shall establish when starting a collaboration session. In some embodiments, a system administrator may customize such information. After establishing the collaboration space, the system 100 establishes one or more viewports based on the predefined viewport information, and for each viewport, establishes a messaging session associated with the viewport (step 306).

The system then allows users to join into the collaboration session. Many known methods may be used for users to join into the collaboration session. For example, in one embodiment, the system 100 generates a collaboration session ID and a session password. Users who provide the correct collaboration session ID and password are joined into the collaboration session.

When a user joins in the collaboration session (step 308), the system 100 associates the newly joined user with a viewport (step 310). For example, in one embodiment, the system designates a default viewport and associates all newly joined users with the default viewport. In another embodiment, the system allows the user to select a viewport, and associates the user with the selected viewport.

At this step, the system also joins the user into the messaging session associated with the viewport, establishing an association between the user and the messaging session.

Once the user is associated with a viewport, the system 100 then displays the content of the viewport, or more accurately, the collaboration space and the graphic objects therein that overlap the viewport, on the screen of the user's computing device (step 312).

At step 314, the system 100 repeatedly checks if another user has joined into the collaboration session. If yes, the process 300 loops to step 310 to associate the newly joined user with a viewport.

If at step 314, no new user joined into the collaboration session, the system 100 checks if any user input is received (step 316). If not, the process loops to step 314.

If at step 316, user input is received, the system 100 manipulates the collaboration space and graphic objects therein based on received user input (step 318). The system 100 also transmits communication data between users in the same messaging session.

As described before, a user in the collaboration session may initiate commands to manipulate graphic objects. System 100 responses to such commands in known manner, which is omitted here.

A user in the collaboration session may also initiate commands to manipulate the viewport that the user is currently associated with, e.g., moving the viewport to a different location in the collaboration space, rotating the viewport, and zooming-in or zooming-out the viewport. System 100 responses to such commands in known manner.

A user in the collaboration session may further initiate commands causing changes to user-viewport association. For example, a user may initiate a command to switch to a different viewport, or to create new viewports.

In response to user commands causing changes to user-viewport associations, the system 100 dynamically updates the user-viewport associations and the corresponding user-messaging session associations (step 320, described in more detail later). Then process then loops to step 314 to monitor for new users.

Although not shown in the flowchart of FIG. 9, the system closes the collaboration session either when a command for closing the collaboration session is received from a user in the session, or when all users in the session have quit from the collaboration session.

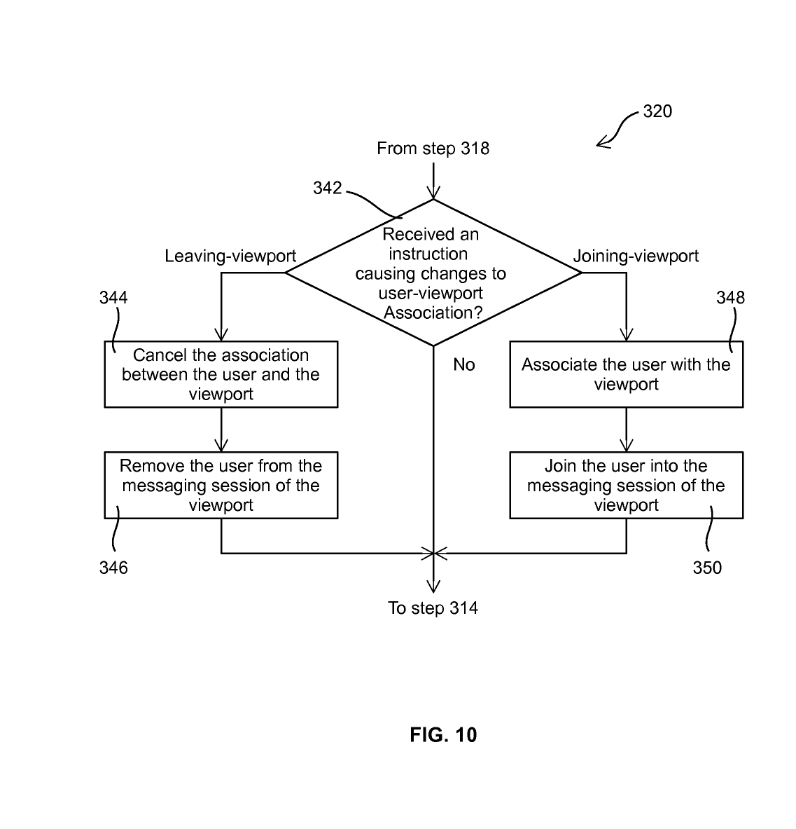

FIG. 10 shows the detail of step 320 of updating the user-viewport associations and the corresponding user-messaging session associations. For ease of illustration, FIG. 10 only shows two basic instructions causing changes to user-viewport association, namely, a joining-viewport instruction and a leaving-viewport instruction. User commands causing changes to user-viewport association may be a combination of the two basic instructions or a combination of any of the two basic instructions and other suitable instructions. Therefore, steps in FIG. 10 may be executed multiple times for a user command.

For example, a user command for switching to another viewport is a combination of a leaving-viewport instruction, for leaving the viewport that user's is currently associated therewith, and a joining-viewport instruction, for joining another viewport that user has designated. A user command for creating a new viewport is a combination of creating a new viewport instruction, and a joining-viewport instruction for joining the newly created viewport. A user command of leaving the collaboration session comprises a leaving-viewport instruction for leaving the viewport that the user is currently associated therewith.

As shown in FIG. 10, at step 342, the system 100 checks if an instruction causing changes to the user-viewport association is received. If no such instruction is received, the process loops back to step 314 of FIG. 9.

If, at step 342, a leaving-viewport instruction is received indicating that a user is to leave their associated viewport, the system cancels the association between the user and the viewport (step 344), and removes the user from the associated messaging session for the viewport (step 346). In this embodiment, the system 100 also displays an indication of leaving the viewport on the screen of the user's computing device. The process then loops back to step 314 of FIG. 9.

If, at step 342, a joining-viewport instruction is received with a designation of viewport, e.g., an ID or a pointer of a viewport, the system associates the user with the designated viewport (step 348), and joins the user into the messaging session associated therewith (step 350). The process then loops back to step 314 of FIG. 9.

With the process 300, the system 100 establishes a plurality of messaging sessions, and associates the messaging sessions with users in the collaboration space based on the users' positions or areas in the collaboration space. In this embodiment, a user's position or area in the collaboration space is represented by the viewport, and thus the users associated with the same viewport are associated with the same messaging session. A user joining or leaving a viewport changes his/her position or area in the collaboration system and thus changes the messaging session associated with the user.

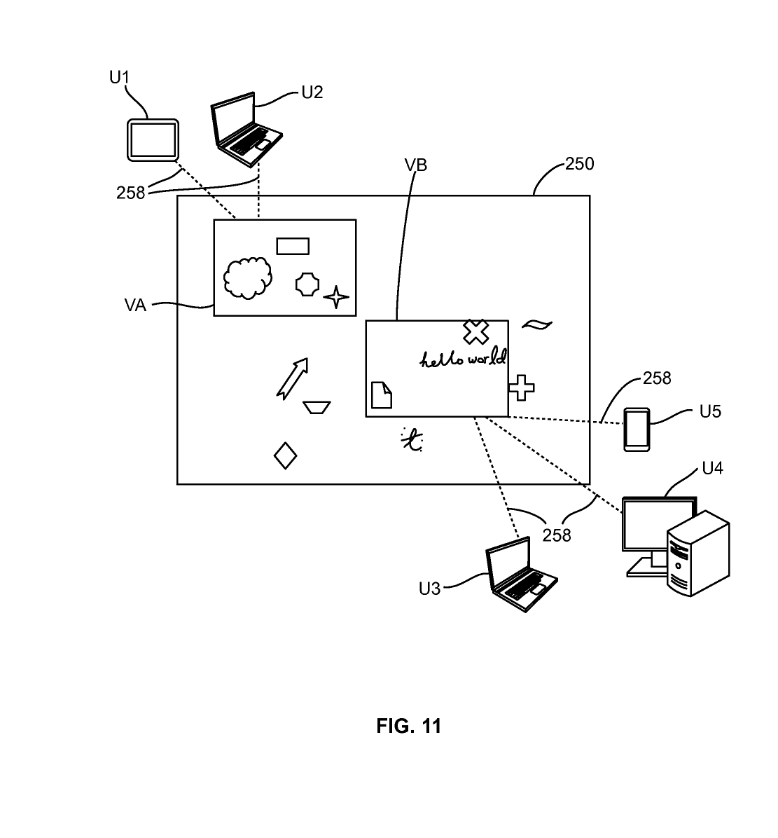

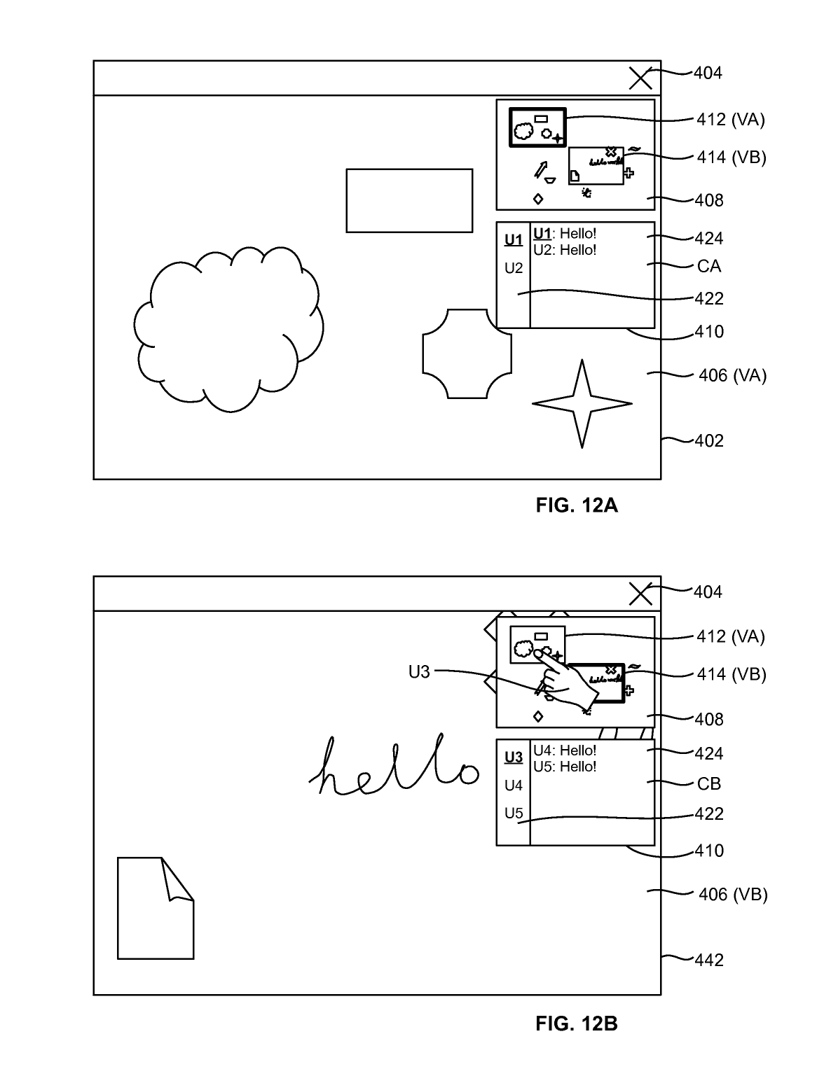

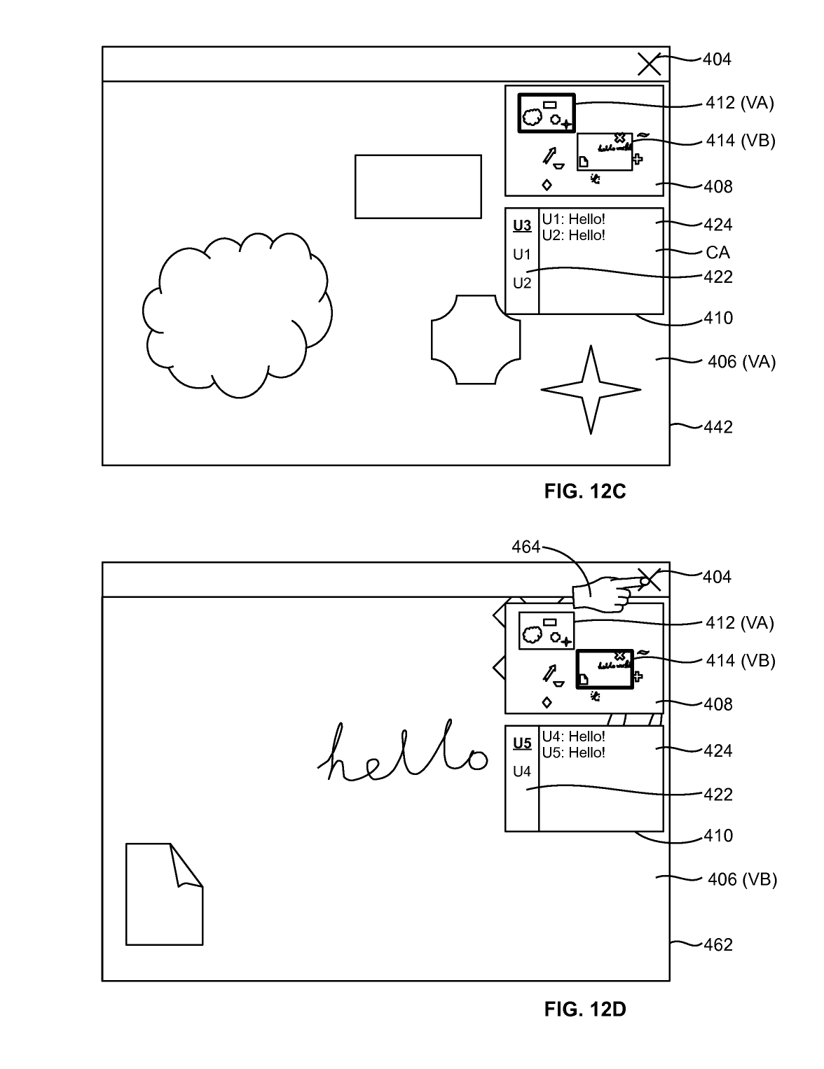

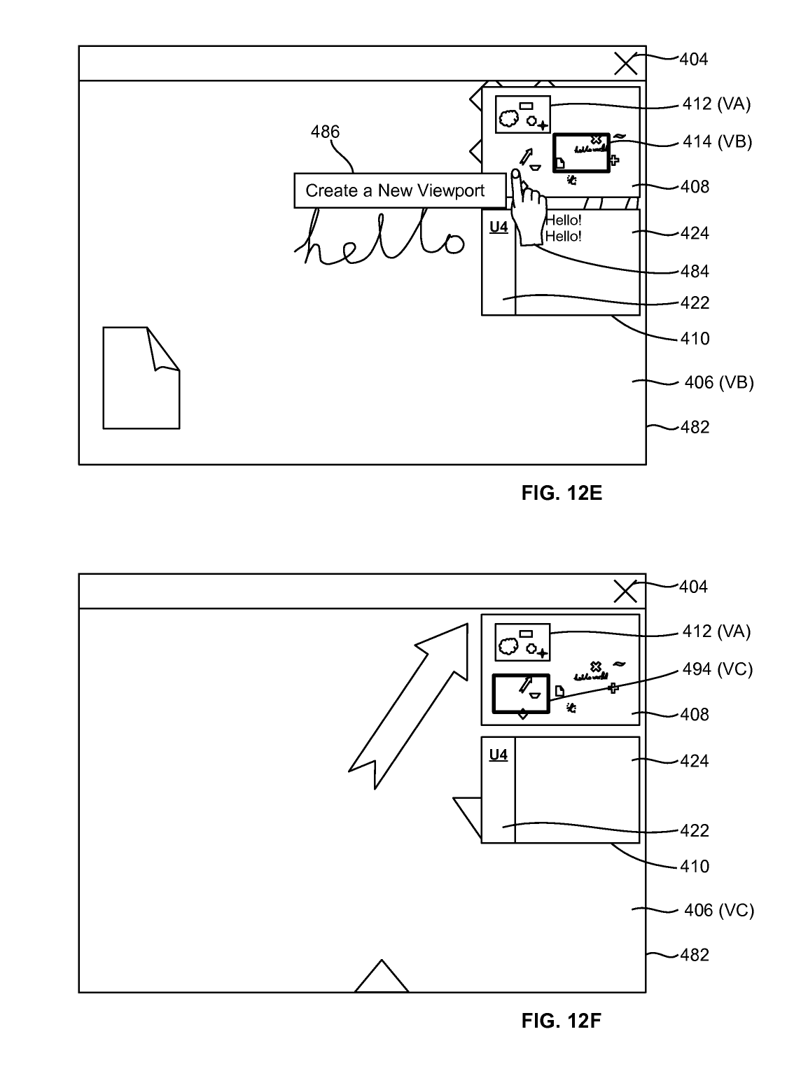

FIGS. 11 to 12F illustrate some examples of managing the messaging sessions based on user viewing positions or areas.

FIG. 11 shows a collaboration space 250 and two viewports VA and VB therein. Users U1 and U2 are viewing the viewport VA and users U3, U4 and U5 are viewing the viewport VB. For the ease of description, all users U1 to U5 are using computing devices with touch-sensitive screens.

In this example, viewports VA and VB are associated with messaging sessions CA and CB, respectively.

FIG. 12A shows the screen image 402 of viewport VA displayed on the screens of U1. As shown, the screen image 402 shows the content 406 of the viewport VA. The screen image 402 also comprises a Close-button 404 for quitting the collaboration session, a thumbnail 408 of the collaboration space 250 and a communication interface 410.

The thumbnail 408 shows a miniature of the collaboration space 250 with indications 412 and 414 indicating the positions of viewports VA and VB, respectively. The indication 412 is highlighted with thick borders to show that it is the current viewport of user U1, i.e., the viewport VA that is currently associated with user U1.

The communication interface 410 comprises a list 422 of users in the current messaging session CA, which includes two users U1 and U2. As the screen image is for displaying on the computing device of user U1, the name of user U1 is highlighted with a bold font and underline.

The communication interface 406 also comprises a communication window 424 showing the content exchanged between the users in messaging session CA. In this embodiment, the messaging session is a text messaging session, and the communication window 424 shows the text messages sent from the users therein. Other users, e.g., users U3, U4 and U5, are not joined with messaging session CA, and thus cannot communicate with users U1 and U2 via messaging session CA.

FIG. 12B shows the screen image 442 of viewport VB displayed on the screens of U3. The screen image 442 of viewport VB comprises similar components as the screen image 402 of viewport VB, which are denoted using same numerals. However, in FIG. 12B, the list 422 lists the names of users U3, U4 and U5 currently in messaging session CB, with the name of user U3 being highlighted with a bold font and underline. Also, the indication 414 of viewport VB is highlighted with thick borders to show that it is the viewport associated with user U3. The communication window 424 shows the messages sent from users in messaging session CB. As other users, e.g., users U1 and U2, are not in messaging session CB, they cannot communicate with users U3, U4 and U5 via messaging session CB.

Also shown in FIG. 12B, the user U3 touches the indication 412 of the viewport VA to switch from viewport VB to viewport VA. Following the process 300 in FIGS. 9 and 10, in response to this user command, the system 100 cancels the association between user U3 and viewport VB (step 344), and removes user U3 from messaging session CB (step 346). Then, the system 100 associates user U3 with viewport VA, (step 348) and joins user U3 into messaging session CA (step 350). As shown in FIG. 12C, the screen image 442 of user U3 now shows viewport VA, and the communication window 422 shows that user U3 is now in communication with users U1 and U2 having joined with and via messaging session CA.

In this embodiment, when U3 joins messaging session CA, the historical messaging data thereof, e.g., the historical text messages, are presented in the communication window 424 of the screen image 442 of U3 such that user U3 may review the historical communication to understand the collaboration history. However, the historical communication data of messaging session CB is not copied nor otherwise moved into messaging session CA.

FIG. 12D shows the screen image 462 displayed on the screen of U5. As user U5 is associated with viewport VB, the screen image 462 displays the content 406 of viewport VB. The communication window 422 lists users U4 and U5 as they are the only remaining users currently in messaging session CB.

Also shown in FIG. 12D, user U5 touches 464 the Close-button 404 of the screen image 462 to quit the collaboration session. Following the process 300 in FIGS. 9 and 10, and in response to this user command, the system cancels the association between user U5 and viewport VB (step 344), removes user U5 from messaging session CB (step 346), and removes user U5 from the collaboration session. FIG. 12E shows the screen image 482 displayed on the screen of U4. As can be seen, the messaging session of viewport VB now only comprises user U4.

Also shown in FIG. 12E, in one embodiment, user U4 touches 484 the thumbnail 408 of the collaboration space 250 for a predefined period of time to pop up a contextual menu 486 comprising a menu item “Create a New Viewport”. User U4 then selects the menu item “Create a New Viewport”. In response to this user command, the system 100 creates a new viewport VC at the designated location in the collaboration space designated by user U4, and establishes a messaging session CC for viewport VC. The system 100 then cancels the association between viewport VB and user U4 (step 344), removes user U4 from messaging session CB (step 346), associates user U4 with the newly created viewport VC, (step 348) and joins user U4 into messaging session CC (step 350). As the viewport VC is a newly created viewport, messaging session CC does not have any historical communication data. Those skilled in the art appreciate that, in other embodiments, a user may use other suitable user interface to initiate a create-new-viewport command, and the system responses to such command as described above.

The system 100 deletes viewport VB as it now has no user associated therewith.

FIG. 12F shows the screen image 482 displayed on the screen of U4 after viewport VC is created. User U4 can now view the viewport VC, and is included in messaging session CC. The thumbnail 408 of the collaboration space 250 shows the indications 412 and 494 of viewports VA and VC, but does not show any indication of the deleted viewport VB.

Those skilled in the art appreciate that other embodiments are readily available. For example, in an alternative embodiment, messaging sessions may transmit multimedia information, e.g., image, animation, audio/video clips, etc., between users therein.

In an alternative embodiment, messaging sessions may be used to provide users with additional information regarding the collaboration space. For example, when a user has made a change, e.g., adding an image, removed a line, or modified a text object, in the collaboration space overlapping a viewport, the system 100 can automatically generate a system message and broadcast it in the corresponding messaging session to notify associated users therein about the change. Such a system message can include hyperlinks to the change made in the collaboration space. Users may also send messages having specific hyperlinks.

As described above, in one embodiment, when a user joins the collaboration session, the system allows the user to select which viewport to join. In an alternative embodiment, when a user joins the collaboration session, the system provides the user with a list of available viewports. Each item of the viewport list corresponds to a viewport, and comprises relevant information thereabout, including, the names of the users associated therewith, recent messages communicated via the messaging session associated therewith, and the like. Such information facilitates a user's understanding regarding the collaboration space and enable a user to readily select a viewport to join.

In an alternative embodiment, when a user joins a viewport, the system displays an indication, such as an animation, on the screens of all users in the viewport to notify them that another user has joined their viewport and messaging session.

In an alternative embodiment, when a user leaves a viewport, the system displays an indication, such as an animation, on the screens of other users in the viewport to notify them that a user has left.

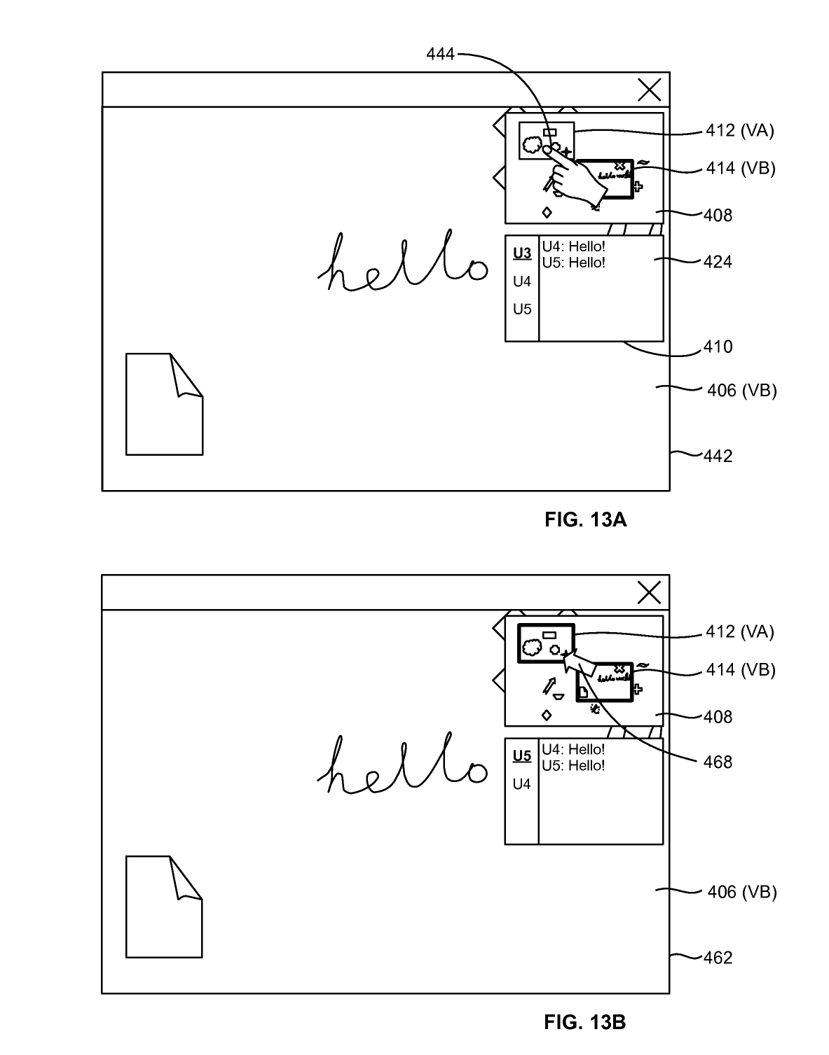

In an alternative embodiment, when a user UL switches from a first viewport to a second viewport, the system displays a directional indication, such as an animation, on the screens of other users in the first viewport to notify them that user UL has moved to another viewport. For example, FIG. 13A shows the screen image 442 of user U3. As shown, user U3 is currently viewing viewport VB with users U4 and U5. User U3 now touches 444 the image 412 of another viewport VA in the thumbnail 408 of the collaboration space to switch thereto. As shown in FIG. 13B, which illustrates the screen image 462 of U5, the images 414 and 412 of both viewports VB and VA, respectively, are highlighted, and an arrow 468 is shown extending from the image 414 of viewport VB to the image 412 of viewport VA, indicating that user U3 has switched to viewport VA along the direction indicated by the arrow 468. A similar indication is also shown on the screens of other users viewing viewport VB, e.g., user U4.

Similarly, an indication may also be displayed on the screens of all users of viewport VA to indicate that user UL has switched to viewport VA from viewport VB.

In some alternative embodiments, the system established a messaging session for users associated with a group of interrelated viewports. In these embodiments, a set of viewports are interrelated if they overlap a common area of the collaboration space, the size of which is more than a predefined percentage threshold of that of at least one of the set of viewports. The predefined percentage threshold may be any suitable percentage depending on the system design. For example, in one embodiment, the percentage threshold is zero (0), meaning that, any overlap between two viewports will cause them interrelated. In some other embodiments, the percentage threshold may be a non-zero percentage, e.g., 20%.

The process of the system in these embodiments is generally the same as that of FIGS. 9 and 10 except that step 320 now conducts additional test and actions.

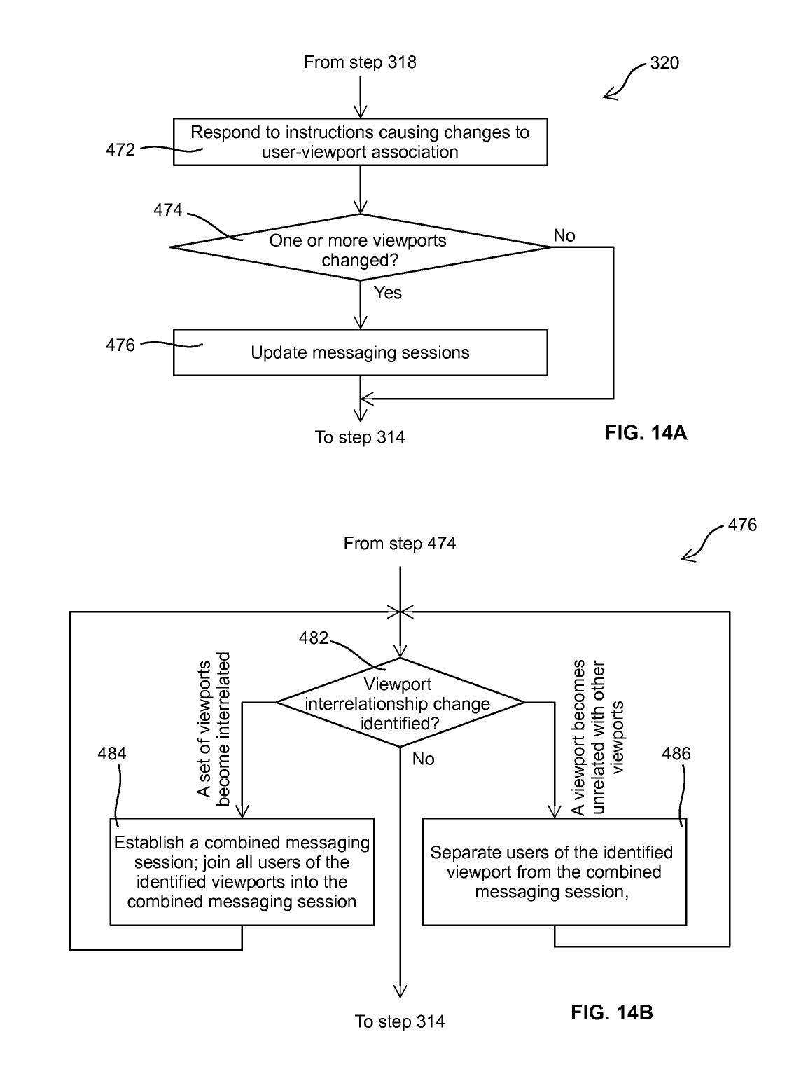

With reference to FIG. 14A, at step 472, the system 100 responds to instructions causing changes to user-viewport association. The detail of this step is the same as that set forth previously in FIG. 10.

Then, the system 100 checks if one or more viewports have been changed (step 474), e.g., being moved to another location in the collaboration space, being size-enlarged, being size-reduced, or being rotated. If no viewport is changed, the process loops to step 314 of FIG. 9.

If at step 474, it is determined that one or more viewports are changed, the system 100 updates the messaging sessions (step 476), and the process loops to step 314 of FIG. 9.

FIG. 14B shows the detail of step 476. As shown, the system 100 checks if any viewport interrelationship is changed (step 482). If no viewport interrelationship is changed, the process goes to step 314 of FIG. 9.

If at step 482, the system 100 identifies that a set of viewports becomes interrelated, the system 100 establishes a messaging session, associates it with the identified interrelated viewports, and joins all users associated with the identified interrelated viewports into the combined messaging session (step 484). The process then loops to step 482 to identify further viewport interrelationship changes.

If at step 482, the system 100 identifies that one of a group of interrelated viewports now becomes unrelated therewith, the system 100 separates the identified viewport from the corresponding combined messaging session by cancelling the association between the identified viewport and the combined messaging session, removing users of the identified viewport from the combined messaging session, establishing a messaging session and associating it with the identified viewport, and joining the users associated with the viewport into the newly established messaging session.

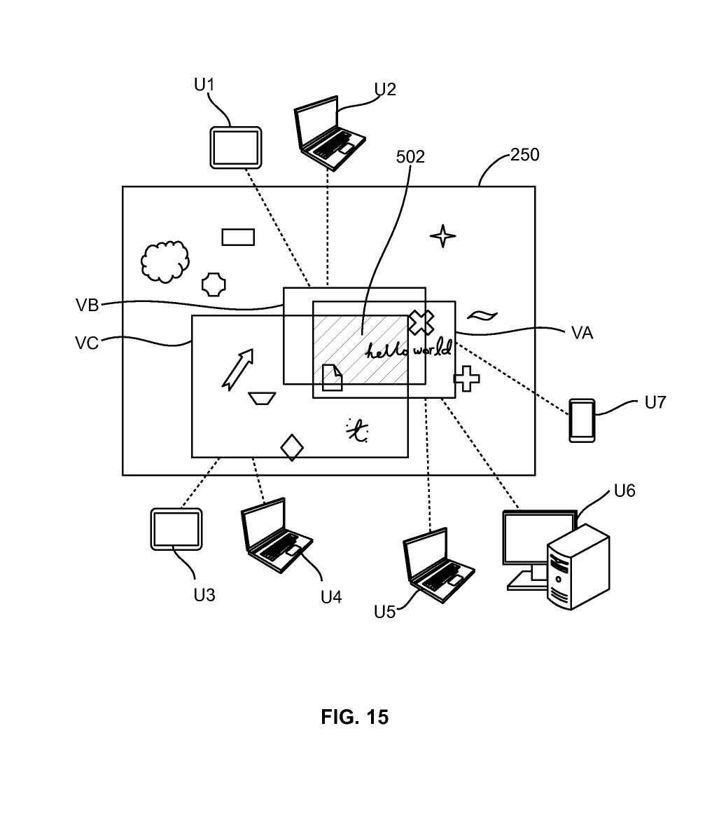

FIGS. 15 to 17 show an example of updating messaging sessions. As shown in FIG. 15, three viewports VA, VB and VC are created in the collaboration space 250, and are associated with messaging sessions CA, CB and CC, respectively. Users U1 and U2 are associated with viewport VB, users U3 and U4 are associated with viewport VC, and users U5, U6 and U7 are associated with viewport VA. In this example, the size of viewport VA is the same as that of viewport VB, but the size of viewport VC is larger than that of viewport VB or VC.

Upon users' manipulation (not shown), the viewports VA, VB and VC are shown to now overlap a common area 502 of the collaboration space 250, and the size of the common area 502 is more than the predefined percentage threshold, e.g., 20%, of that of viewport VA.

Following the steps of FIG. 14B, the system 100 identifies changes in the viewport interrelationship (step 482) and determines that the viewports VA, VB and VC become interrelated. The system 100 thus establishes a combined messaging session CG, and associates it with viewports VA, VB and VC. The system 100 then joins users U1 to U7 into the combined messaging session CG (step 484).

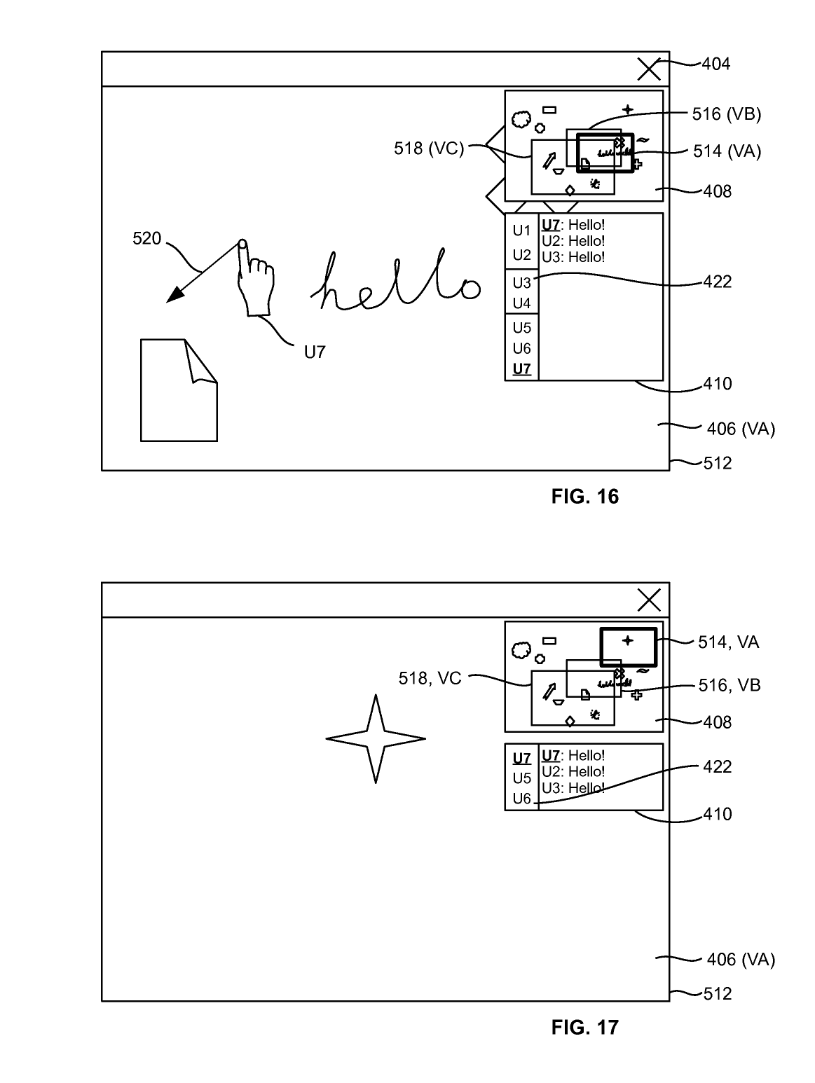

FIG. 16 shows the screen image 512 of viewport VA displayed on the screen of U7. As shown, the user list 422 of the communication window 410 lists all users U1 to U7 associated with viewports VA, VB and VC.

Although the users associated with viewports VA, VB and VC are merged to the combined messaging session CG, in this embodiment, the associations of users U1 to U7 and viewports VA, VB and VC are not merged nor otherwise changed. Therefore, as shown in FIG. 16, users in the list 422 are grouped to three groups indicating their viewport associations.

User U7 applies a collaboration space moving command to move the collaboration space in viewport VC along the direction indicated by the arrow 520. The collaboration space moving command is then converted to a viewport moving command, moving the viewport VA that user U7 is associated therewith towards a direction opposite to the arrow 520, to a location in the collaboration space (see FIG. 17) such that viewport VA is no longer interrelated with viewports VB and VC. As a result, the association between viewport VA and the combined messaging session CG is cancelled, and users U5, U6 and U7 are removed from messaging session CG. Then, a messaging session CA is established and is associated with viewport VA, and users associated viewport VA are joined into messaging session CA. As shown in FIG. 17, U7 is now only in communication with users U5 and U6. The combined messaging session CG is associated with viewports VB and VC, and comprises users associated therewith, i.e., U1 to U4.

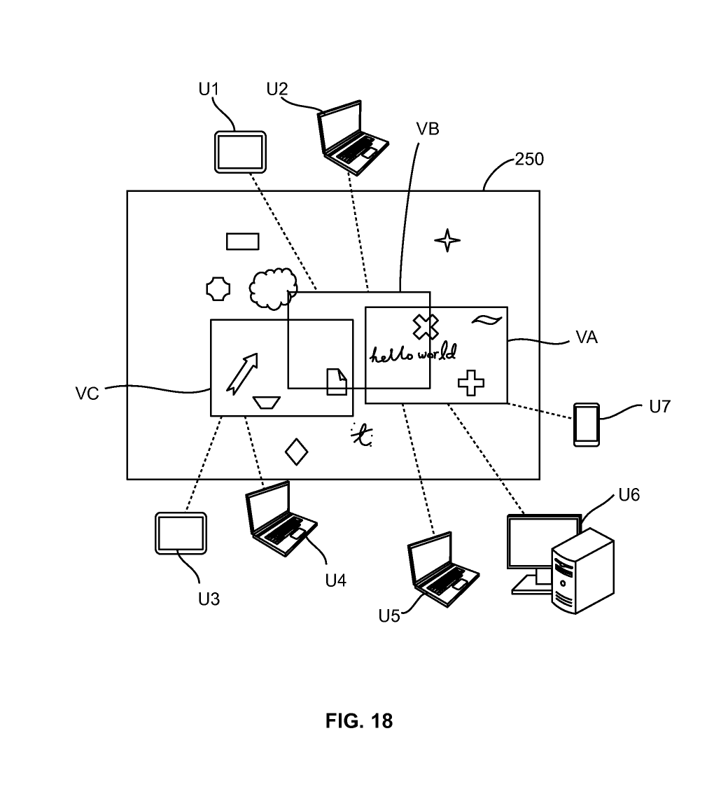

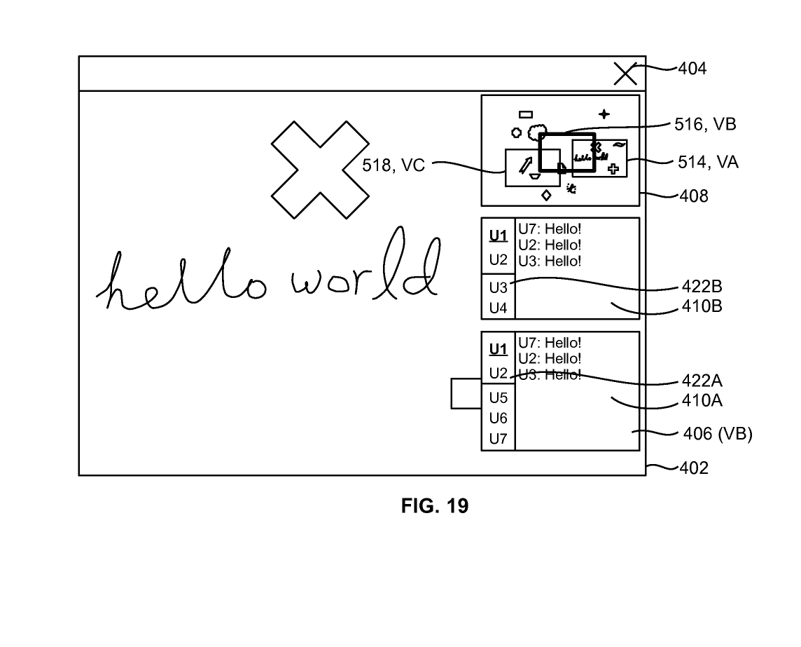

FIGS. 18 and 19 illustrate an example of linked viewports VA and VC. Herein, two or more groups of interrelated viewports are linked if, while the two or more viewport groups VA, VC are not interrelated to each other, they are interrelated to a same viewport VB or same interrelated viewport group. Viewports may also be linked through linked viewports.

As shown in FIG. 18, after user manipulation (not shown), viewport VB becomes separately interrelated with viewports VA and VC. However, viewports VA and VC are not interrelated. The system 100 establishes a combined messaging session C1 for viewports VA and VB, and another combined messaging session C2 for viewports VB and VC.

Consequently, viewport VB and users U1 and U2 associated therewith, are now associated with two combined messaging sessions C1 and C2. As shown in FIG. 19, the screen image 402 of user U1 comprises two communication interfaces 410A and 410B. The communication interface 410A shows the communication occurred in messaging session C1, and lists users U1, U2, U5, U6 and U7 therein. The communication interface 410B shows the communication occurred in messaging session C2, and lists users U1, U2, U3 and U4 therein.

As viewport VB is now associated with multiple messaging sessions, when a user thereof leaves viewport VB, the system 100 removes the user from all messaging sessions associated with viewport VB.

Similarly, when another user joins viewport VB, the system 100 joins the user into all messaging sessions associated with viewport VB.

If viewport VB is moved, the system 100 checks all viewports it interrelated thereto, and determines changes of the viewport interrelationships. If any change is determined, the system updates messaging sessions accordingly.

In above embodiment, multiple combined messaging sessions are established for linked viewports. In an alternative embodiment, the system 100 only establishes one messaging session for linked viewports.

In yet another embodiment, the system 100 establishes one or more messaging sessions for linked viewports based on information of the viewport and/or the messaging sessions thereof, such as the number of users in each messaging session, the time duration of users in each viewport, the overlapping percentage between the viewports, etc. For example, in a situation similar to FIG. 18, where viewports VA and VC are linked via a common, overlapping viewport VB, the system 100 first establishes a first combined messaging session for viewports VA and VB, and a second combined messaging session for viewports VB and VC, as shown in FIG. 19. After users of viewports VA, VB and VC collaborate together for a predefined time threshold, the system 100 merges all users of viewports VA, VB and VC into a single messaging session.

In an alternative embodiment, the system creates a viewport for each user in a collaboration session, and associates the user therewith. The user may manipulate the associated viewport without interfering other users in viewing the collaboration space.

The process in this embodiment is similar to that of FIGS. 9, 10, 14A and 14B, except that, in this embodiment, the system 100 does not create any viewports before any user joins in. Rather, the system 100 dynamically creates a viewport at a default location of the collaboration space for each user joining into the collaboration session. Moreover, in this embodiment, each viewport is only associated with one user, and thus users cannot switch to other users' viewports.

In this embodiment, users may move their respective viewports in the collaboration space to interrelate other viewports and collaborate with the users associated therewith. A messaging session is automatically established for users associated with interrelated viewports. A user may leave a messaging session by moving his/her viewport away or by quitting the collaboration session.

In above embodiments, once a viewport VN of a group of interrelated and/or linked viewports becomes unrelated therewith, the system cancels the association between viewport VN and the combined messaging session of the viewport group, removes users of viewport VN from the combined messaging session, establishes a messaging session and associating it with the viewport VN, and joins the users associated with viewport VN into the newly established messaging session. However, in an alternative embodiment, when the viewport VN is unrelated with the viewport group, the system does not cancel the association between viewport VN and the combined messaging session of the viewport group, nor remove users of viewport VN from the combined messaging session. Rather, the system only establishes a messaging session and associates it with the viewport VN, and joins the users associated with viewport VN into the newly established messaging session. Each user of viewport VN has to manually quit from the combined messaging session of the viewport group.

In an alternative embodiment, the system also establishes a global messaging session for all users such that a user may broadcast communication data to all other users in the collaboration session, or communicate with another user who is not currently viewing about the same place of the collaboration space.

In above embodiments, the collaboration space is a two-dimensional (2D) space such as a canvas. In an alternative embodiment, the collaboration space is a three-dimensional (3D) space. In this embodiment, the viewport is a 3D space in the collaboration space, the location of which represents the position or area of the associated user in the 3D space. Similar to the 3D viewport described above, the 3D viewport may be moved in the 3D collaboration space, turned to various angles, and/or zoomed-in or out. Similar to the embodiments described above, the system establishes a plurality of messaging sessions and associates them with users based on the users' positions or areas in the 3D collaboration space.

In an alternative embodiment, the system allows at least some users, e.g., system administrator(s), to customize the predefined viewport overlapping percentage threshold.

According to this disclosure, the system establishes one or more private, combined messaging session for interrelated or linked users. In above embodiments, the system establishes such private messaging sessions by identifying one or more positions or areas within the collaboration space, each of which is attended by at least one user, establishing a messaging session for each identified position or area, and associating each user attending the same position or area with the same messaging session.

Each of such messaging sessions is private or localized in the sense that, although all users in the collaboration session are generally collaborating with each other towards a same goal, each of the private messaging session is established only for a subset of the users who are currently interrelated, or in some of above embodiments, linked. In above embodiments, the interrelationship or linkage of users is determined based on the overlapping of their viewports or positions. In some alternative embodiments, users may be interrelated based on other position-based criteria. For example, in one embodiment, the system establishes a plurality of zones in the collaboration space. Users in the same zone are determined as interrelated, and the system establishes a private messaging session for them.

In some other embodiments, user interrelationship may be determined by non-position-related criteria. For example, in one embodiment, a plurality of messaging “gadgets” are provided, each corresponding to a separate messaging session. Users using the same messaging “gadget” are considered as interrelated regardless their positions in the collaboration space, and are joined with the same messaging session of the “gadget”.

In some embodiments, the determination of user interrelationship and the establishment of a private messaging session is based on both user positions and other, non-position information. For example, in one embodiment, the system identifies one or more graphic objects in the collaboration space as “critical” objects either automatically based on predefined rules or in response to users' instructions. The system then monitors user positions in the collaboration space, and establishes a private messaging session for each group of users overlapping a critical objects. In other words, the system does not establish any private messaging session for position-overlapped users if the overlapping position does not encompass any critical object.

Although embodiments have been described above with reference to the accompanying drawings, those of skill in the art will appreciate that variations and modifications may be made without departing from the scope thereof as defined by the appended claims.

What is claimed is:

1. A computerized method of managing a collaboration space having a plurality of users collaborating therein, the method comprising:
identifying one or more areas within the collaboration space, each of the one or more areas being attended by at least one user;
establishing a messaging session for each identified area; and
associating each user attending the same area with the same messaging session.

2. The method of claim 1 wherein each user is associated with a viewport, and wherein each viewport represents at least a portion of the one or more areas.

3. The method of claim 2 wherein said establishing a messaging session for each identified area comprises:
for each viewport,
establishing a messaging session for users associated therewith; and
associating said messaging session with said viewport.

4. The method of claim 2 wherein said establishing a messaging session for each identified area comprises:
identifying a first set of interrelated viewports, said first set of interrelated viewports being a first plurality of viewports that overlap a first common area of the collaboration space, the size of said first common area being more than a predefined threshold percentage of that of at least one of said a first plurality of viewports; and
establishing a first messaging session for users associated with the first set of interrelated viewports.

5. The method of claim 4 wherein said establishing a messaging session for each identified area further comprises:
associating said first messaging session with the first set of interrelated viewports.

6. The method of claim 5 wherein said establishing a messaging session for each identified area in the collaboration space further comprises:
identifying a second set of interrelated viewports, said second set of interrelated viewports being a second plurality of viewports that overlap a second common area of the collaboration space, the size of said second common area being more than a predefined threshold percentage of that of at least one of said a second plurality of viewports; and
establishing a second messaging session for users associated with the second set of interrelated viewports.

7. The method of claim 6 wherein said establishing a messaging session for each identified area further comprises:
associating said second messaging session with the second set of interrelated viewports.

8. The method of claim 7 wherein the first and second sets of viewports comprise at least one common viewport, and each user associated with said at least one common viewport is simultaneously in the first and second messaging sessions.

9. The method of claim 2 wherein said establishing a messaging session for each identified area in the collaboration space comprises:
identifying a first set of interrelated viewports;
identifying a second set of interrelated viewports, the second set of interrelated viewports being linked to the first set of interrelated viewports via a set of intermediate viewports;
establishing a messaging session for users associated with the first and second sets of viewports; and
associating said messaging session with the first and second sets of viewports.

10. The method of claim 2 further comprising:
receiving a command from a user, said command comprising an instruction of associating the user with a target viewport;
associating the user with the target viewport; and
joining the user into every messaging session associated with the target viewport.

11. The method of claim 2 further comprising:
receiving a command from a user, said command comprising an instruction of leaving the viewport that the user is associated therewith;
cancelling the association between the user and said viewport; and
removing the user from every messaging session associated with said viewport.

12. The method of claim 2 further comprising:
determining that a first viewport of a set of interrelated viewports becomes unrelated with said set of interrelated viewports;
removing users of the first viewport from every messaging session associated with said set of interrelated viewports; and
establishing a messaging session for users associated with the first viewport.

13. The method of claim 2 further comprising:
determining that a second viewport becomes interrelated with one or more third viewports; and
establishing a messaging session for users associated with the second viewport and the one or more third viewports.

14. A system for managing a collaboration space having a plurality of users collaborating therein, the system comprising:
a network;
a plurality of processing structures functionally coupled to said network; and
at least one memory functionally coupled to at least one of said processing structures; wherein said at least one of said processing structures executes computer-executable code for:
identifying one or more areas within the collaboration space, each of the one or more areas being attended by at least one user;
establishing a messaging session for each identified area; and
associating each user attending the same area with the same messaging session.

15. The method of claim 14 wherein each user is associated with a viewport, and wherein each viewport represents at least a portion of the one or more areas.

16. The system of claim 15 wherein said computer-executable code for establishing a messaging session for each identified area comprises computer-executable code for:
for each viewport,
establishing a messaging session for users associated therewith; and
associating said messaging session with said viewport.

17. The system of claim 15 wherein said computer-executable code for establishing a messaging session for each identified area comprises computer-executable code for:
identifying a first set of interrelated viewports, said first set of interrelated viewports being a first plurality of viewports that overlap a first common area of the collaboration space, the size of said first common area being more than a predefined threshold percentage of that of at least one of said a first plurality of viewports;
establishing a first messaging session for users associated with the first set of interrelated viewports; and
associating said first messaging session with the first set of interrelated viewports.

18. The system of claim 17 wherein said computer-executable code for establishing a messaging session for each identified area in the collaboration space further comprises computer-executable code for:
identifying a second set of interrelated viewports, said second set of interrelated viewports being a second plurality of viewports that overlap a second common area of the collaboration space, the size of said second common area being more than a predefined threshold percentage of that of at least one of said a second plurality of viewports;
establishing a second messaging session for users associated with the second set of interrelated viewports; and
associating said second messaging session with the second set of interrelated viewports.

19. The system of claim 18 wherein the first and second sets of viewports comprise at least one common viewport, and each user associated with said at least one common viewport is simultaneously in the first and second messaging sessions.

20. The system of claim 15 wherein said at least one of said processing structures further executes computer-executable code for:
receiving a command from a user, said command comprising an instruction of associating the user with a target viewport;
associating the user with the target viewport; and
joining the user into every messaging session associated with the target viewport.

21. The system of claim 15 wherein said at least one of said processing structures further executes computer-executable code for:
determining that a second viewport becomes interrelated with one or more third viewports; and
establishing a messaging session for users associated with the second viewport and the one or more third viewports.

22. A computer-readable storage device comprising computer-executable instructions for managing a collaboration space having a plurality of users collaborating therein, wherein the instructions, when executed, cause a processor to perform actions comprising:
identifying one or more areas within the collaboration space, each of the one or more areas being attended by at least one user;
establishing a messaging session for each identified area; and
associating each user attending the same area with the same messaging session.
